(19) United States
(12) Patent Application Publication
(10) Pub. No.: US 2007/0184674 A1
(43) Pub. Date: Aug. 9, 2007

(54) CONTACT ARRANGEMENT HAVING A BATTERY AND AN ELECTRICAL LINE

(76) Inventor: FRANZ KOCH, REGENSBURG (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 10/597,833

(22) PCT Filed: Feb. 9, 2005
(86) PCT No.: PCT/EP05/01309

§ 371 Date: Jan. 25, 2007

(30) Foreign Application Priority Data
Feb. 9, 2004 (DE) DE102004006259.9

(51) Int. Cl. H01R 11/30

(52) U.S. Cl. 439/39

(57) ABSTRACT

The invention discloses a contact arrangement which has a connection terminal and a connection piece. Permanent magnets are arranged in the connection terminal or in the connection piece, and electromagnets are arranged in the connection piece or in the connection terminal. In each case one contact piece is introduced in the connection terminal and in the connection piece and these contact pieces are in electrically conductive contact with one another in the event of a magnetic attracting force between the connection terminal and the connection piece. The electromagnets are electrically conductively connected to a control device. The permanent magnets and the cores of the electromagnets are matched to one another in such a manner that either a magnetic attracting force or a magnetic repelling force exists between the connection terminal and the connection piece without a current being applied to the electromagnet. If a current is now applied to the electromagnets, the magnetic force effect produced by the permanent magnets is inverted. In this manner it is possible for the control device, when identifying an emergency situation, to interrupt the electrical contact between the connection terminal and the connection piece, i.e. between a battery and a vehicle electrical system, by current being applied to the electromagnets.

The invention relates to a contact arrangement in accordance with the precharacterizing clause of patent claim 1, a connection piece for an electrical line in accordance with claim 11 and a connection terminal for a battery in accordance with claim 12.

Contact arrangements between a battery, in particular a battery of a motor vehicle, and an electrical line should be designed so as to be capable of being automatically interrupted for emergency situations. Firstly, the contact arrangement should not be interrupted during conventional operation of the motor vehicle in order that correct functioning of the electrical device of the motor vehicle is ensured and, secondly, the contact arrangement between the battery and the connected electrical line should be interrupted automatically in the event of an emergency situation, such as an accident, in order to avoid, for example, sparking in the case of a damaged line. Sparking in the case of a damaged line can result in the motor vehicle being ignited, in particular in the case of contact with fuel.

The German utility model G 92 02 423 has disclosed a magnet safety connection for a motor vehicle, in the case of which an electrical line has a permanent magnet, which is arranged on a permanent magnet of the positive terminal of the battery. The two magnets are held together by a safety bracket. The two magnets maintain the current connection between the battery and the line until there is a collision at more than 20 kilometers per hour. The attracting force of the magnets is selected in a corresponding manner, and the upper magnet is loaded with a corresponding metal piece such that the centrifugal force occurring in the event of a collision at more than 20 kilometers per hour releases the upper magnet from the lower magnet. In the event of a collision at more than 20 km/h, the circuit is therefore immediately interrupted.

DE 199 09 123 A1 has disclosed an automatic power shutdown device for emergency situations. The automatic power shutdown device has a collision detection device, an electrically actuable actuator and an electrical switch, with which the electrical connection between an input connection and an output connection of a battery can be disconnected. The power shutdown device is designed such that, when a collision is detected, the actuator is actuated such that the switch opens. For this purpose, a pivoting arm is provided which has an electrical contact which is connected to an electrical line. A fixed contact of a second line is associated with the electrical contact of the pivoting arm. The pivoting arm also has a permanent magnet, which is associated with an electromagnet on one side of the pivoting arm and with a second permanent magnet on the other side of the pivoting arm. In the conducting state, the permanent magnet of the pivoting arm bears against the electromagnet, and the first and the second lines are electrically conductively connected to one another.

If a collision is now identified by the collision detection device, the electromagnet has a current applied to it such that the permanent magnet of the pivoting arm is repelled and comes to bear against the second permanent magnet. The second permanent magnet attracts the permanent magnet of the pivoting arm and holds the pivoting arm in the open position. In this position, the first and second lines are isolated from one another. Only a manual actuation of the pivoting arm can bring the pivoting arm into the closed position again. The design of the pivoting arm is relatively complex and requires a considerable amount of space.

The object of the invention consists in providing a contact arrangement between a battery and an electrical line which has a simple design and requires less space.

The object of the invention is achieved by the contact arrangement in accordance with patent claim 1, by the connection piece in accordance with patent claim 11, and by the connection terminal in accordance with patent claim 12.

One advantage of the contact arrangement in accordance with claim 1 consists in using simple means to achieve a secure and reliable hold of a connection piece of an electrical line on a connection terminal of a battery. This advantage is achieved by the fact that an electromagnet with a magnet core and a magnet coil is arranged in the connection terminal of the battery or in the connection piece of the electrical line and the fact that a permanent magnet is associated with the electromagnet in the mating piece, i.e. in the connection piece or in the connection terminal. The permanent magnet exerts a magnetic force on the magnet core of the associated electromagnet, which involves either attracting or repelling the magnet core. By applying a corresponding current to the magnet coil, the force effect of the permanent magnet is counteracted such that, by applying a corresponding current, the connection piece is released from the connection terminal. The release of the connection piece is desired in particular when an accident situation has been identified and is triggered in a corresponding manner by a control device.

Further advantageous embodiments of the invention are given in the dependent claims.

In one further preferred embodiment, a plurality of permanent magnets are arranged in the connection terminal or in the connection piece, and a plurality of electromagnets are associated with the permanent magnet in the mating piece, i.e. in the connection piece or in the connection terminal. The permanent magnets are preferably arranged symmetrically around an electrical conductor of the connection terminal or of the connection piece. Owing to this arrangement, it is possible for a high magnetic force to be switched by means of the electromagnets being driven. It is thus possible for a high magnetic force to be used in order to retain the connection piece on the connection terminal. This may be required, in particular, if a vehicle is moving on poor stretches of road or in the country. In addition, the magnetic force is sufficient for maintaining the electrical contact between the connection terminal and the connection piece in the event of relatively small accidents.

In one preferred embodiment, the permanent magnets and the electromagnets are arranged separately from one another in the connection piece or in the connection terminal. The application of current to the connection piece or the connection terminal is therefore sufficient for releasing the contact between the connection piece and the connection terminal.

In one further preferred embodiment, both the contact piece of the connection piece and the contact piece of the connection terminal have an essentially planar contact face, which contact faces bear against one another in the contact state and produce an electrically conductive connection between the two contact pieces.

In one further preferred embodiment, the permanent magnets and the magnet cores of the electromagnets associated with the permanent magnets exert mutually repelling magnetic forces. In this embodiment, it is necessary to apply current to the electromagnet in order to retain the connection piece on the connection terminal.

In one further embodiment, the permanent magnets and the magnet cores of the electromagnets associated with the permanent magnet exert mutually attracting magnetic forces. In this embodiment, in order to isolate the connection piece from the connection terminal, it is necessary for the electromagnets to have a current applied to them and to counteract the attracting magnetic force of the permanent magnets.

In one further preferred embodiment, the magnet coils of a plurality of electromagnets of a connection piece or of a connection terminal are connected electrically in series such that two connections are sufficient on the connection piece or on the connection terminal for making contact with all of the magnet coils. In this manner, electrical contact is made in a simple manner with the electromagnets.

The invention will be explained in more detail below with reference to the drawings, in which:

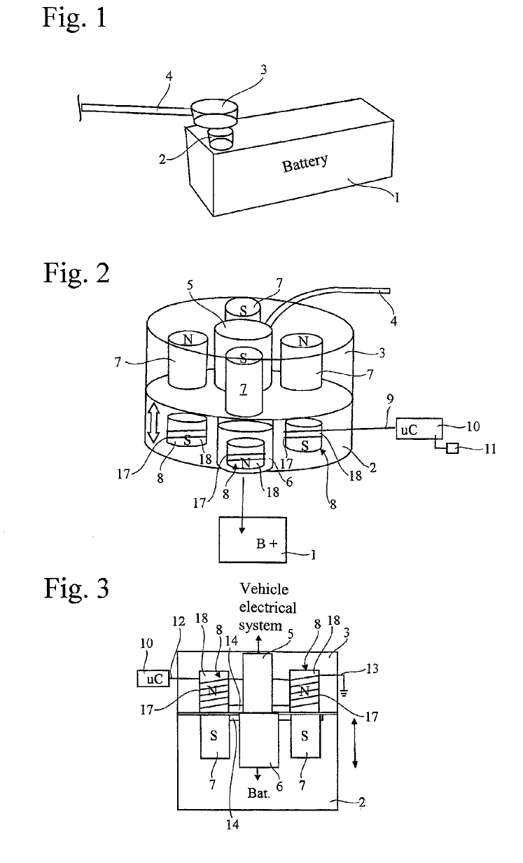

FIG. 1 shows a battery having a connection terminal and a connection piece with an electrical line;

FIG. 2 shows a schematic illustration of the connection terminal and the connection piece with a control device;

FIG. 3 shows a further embodiment of a connection terminal and a connection piece;

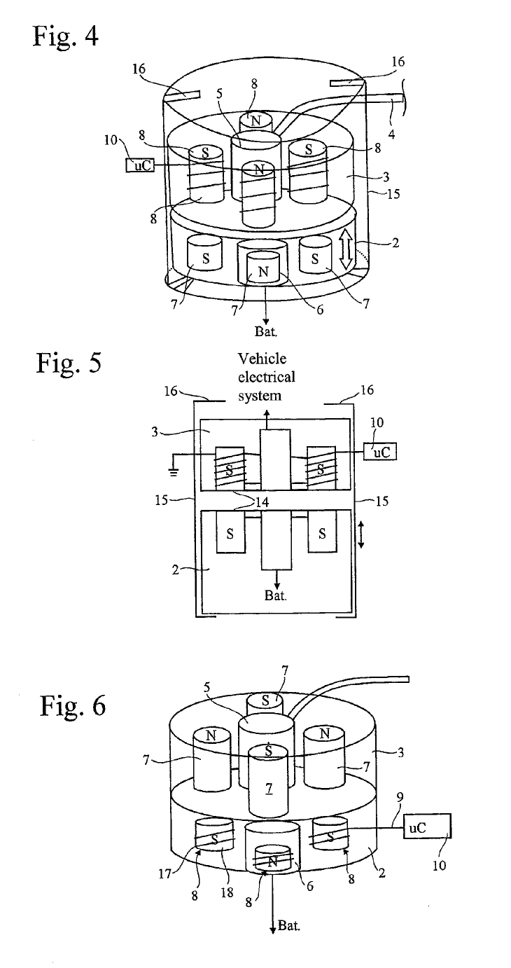

FIG. 4 shows a third embodiment of a connection terminal and a connection piece;

FIG. 5 shows a fourth embodiment of a connection terminal and a connection piece; and

FIG. 6 shows a fifth embodiment of a connection terminal and a connection piece.

FIG. 1 shows a schematic illustration of a battery 1, which is arranged, for example, in a motor vehicle and has a connection terminal 2. The connection terminal 2 represents, for example, the positive terminal of the battery. A connection piece 3 is arranged on the connection terminal 2 and is connected to an electrical line 4. When the battery is arranged in a motor vehicle, the electrical line 4 is connected to the vehicle electrical system of the motor vehicle. The connection piece and the connection terminal make contact with one another such that the electrical line 4 is electrically conductively connected to the positive terminal of the battery 1.

FIG. 2 shows a schematic illustration of a first embodiment of the contact arrangement between the connection terminal 2 and the connection piece 3. The connection terminal 2 has a centrally arranged, first contact piece 5, which is electrically conductively connected to the line 4. Four cylindrical permanent magnets 7 are arranged around the first contact piece 5. The connection piece 3 has the shape of a circular disk and is essentially produced from an insulating plastic material, in which the first contact piece 5, the permanent magnets 7 and a piece of the electrical line 4 are embedded.

The connection terminal 2 of the battery is arranged beneath the connection piece 3, the connection terminal 2 likewise having a centrally arranged, second contact piece 6 which is electrically conductive and is connected with one end to the positive terminal of the battery 1. The second end of the second contact piece 6 has a contact face, which bears against a contact face of the first contact piece 5. In this manner, electrical contact is produced between the first and the second contact piece 5, 6. The second contact piece 6 has four electromagnets 8, which are arranged symmetrically on a circle line around the second contact piece 6 and are incorporated in the connection terminal 2. The connection terminal 2 is in the form of a circular plate, which consists of an insulating plastic material, in which the second contact piece 6 and the electromagnets 8 are embedded. The four electromagnets 8 are arranged symmetrically with respect to the arrangement of the four permanent magnets 7, in each case one electromagnet 8 being positioned directly beneath a permanent magnet 7. The illustration in FIG. 2 only shows three electromagnets. The electromagnets 8 each have a magnet core 18 and a magnet coil 17. The magnet coils 17 of the electromagnets 8 are connected to a control device 10 via electrical lines 9.

In the case of the permanent magnets 7, the magnetic polarization is indicated by letters, N representing the north pole and S representing the south pole. In a corresponding manner, the magnetic polarization of the electromagnets 8 is also represented with respect to the permanent magnets 7 in the form of capital letters. In the embodiment illustrated, the pairs of associated permanent magnets and electromagnets 7, 8 each have opposite polarization, with the result that the permanent magnets and the electromagnets 8 attract one another and therefore the connection terminal 2 and the connection piece 3 are drawn to one another. As a result, the electrically conductive contact between the first and the second contact piece 5, 6 is ensured.

The control device 10 monitors, using sensors 11, whether there is an emergency situation in which the electrically conductive connection between the connection terminal 2 and the connection piece 3 should be interrupted.

If the control device 10 now identifies an emergency situation in which the electrical contact between the electrical line 4 and the battery 1 should be interrupted, the electromagnets 8 are driven by the control device 10 via the second electrical lines 9 such that their magnetic polarization is inverted and the permanent magnets 7 and the electromagnets 8 repel one another. As a result, the connection piece 3 is repelled by the connection terminal 2 such that the electrically conductive connection between the first and the second contact piece 5, 6 is interrupted.

Depending on the embodiment of the invention chosen, when no current is applied to the electromagnets 8, the magnetic attracting force is produced either merely by an iron core of the electromagnet 8 or by the induction produced in the iron core of the electromagnet 8 by means of the permanent magnets 7. In this embodiment, it is not necessary in the closed state for the electromagnets 8 to have a current applied to them. Furthermore, it may be advantageous to design the magnet cores of the electromagnets 8 to be in the form of permanent magnets, which have a desired magnetic polarization, i.e. either an attracting or repelling magnetic force with respect to the permanent magnet 7 of the connection piece 3. It is also possible, in order to assist the attracting force even in the contact state, to apply current to the electromagnets 8 such that the magnetic force with which the permanent magnets 7 and the electromagnets 8 attract one another is produced or increased.

Depending on the desired embodiment, it is sufficient if in each case only one permanent magnet 7 and one electromagnet 8 are used in order to provide the desired magnetic attracting or repelling force.

FIG. 3 shows a second embodiment of the contact arrangement with the connection terminal 2 and the connection piece 3, but in contrast to the first embodiment in FIG. 2, the electromagnets 8 are arranged in the connection piece 3. Correspondingly, the permanent magnets 7 are arranged in the connection terminal 2. This illustration shows a preferred embodiment of the electromagnets 8, in which all of the magnet windings of the electromagnets are connected in series with one another, and the four electromagnets 8 can therefore be driven via only two connections 12, 13. The first and the second contact piece 5, 6 have contact faces which are associated with one another and bear against one another in the contact state, as illustrated in FIG. 3. In one preferred embodiment, the first and the second contact piece 5, 6 are guided out slightly over the surfaces of the connection terminal 2 and of the connection piece 3. The connection terminal 2 and the connection piece 3 therefore bear against one another essentially only in the region of the first and the second contact piece 5, 6. The permanent magnets 7 on one side and the electromagnets 8 on the other side are therefore at a fixed distance from one another. In this embodiment, it is therefore not necessary to apply a protective layer to the permanent magnets 7 and the electromagnets 8 on the surface of the connection terminal 2 and of the connection piece 3 since they do not come into contact with one another even in the contact state, as is illustrated in FIG. 3. In one preferred embodiment, the permanent magnets and electromagnets 7, 8 which are associated with one another bear against one another and come into contact with one another in the contact state.

In one further preferred embodiment, the first and the second contact piece 5, 6 are essentially cylindrical, and the second contact piece 6 has a greater diameter than the first contact piece 5. FIG. 3 shows, corresponding to FIG. 2, an embodiment in which the connection terminal 2 and the connection piece 3 are given, even without a current being applied to the electromagnets 8, by the corresponding selection of the polarization of the permanent magnets 7 and the magnet cores 18 of the electromagnets 8 in the state in which no current is applied. In the embodiment illustrated, the permanent magnets 7 have a magnetic south pole on the side associated with the electromagnets 8. The iron cores of the electromagnets 8 each have a magnetic north pole on the side associated with the permanent magnet 7, under the influence of the permanent magnets 7. Depending on the embodiment selected, permanent magnets can also be selected as the magnet cores in place of the iron cores for the electromagnets 8.

For a precise adjustment of the first and the second contact piece 5, 6 and the permanent magnets 7 and the electromagnets 8, it is advantageous, as shown in FIG. 3, to provide in each case one holding plate 14, into which the first contact piece 5 and the electromagnets 8 or the second contact piece 6 and the permanent magnets 7 are inserted and held. The holding plate 14 for this purpose has a correspondingly high degree of rigidity and strength in order to precisely hold the first contact piece 5 and the electromagnets 8 or the second contact piece 6 and the permanent magnets 7. Owing to the design of the holding plate 14, it is possible to produce the remaining volume of the connection terminal 2 and the remaining volume of the connection piece 3 from an insulating material, which has, for example, a lower degree of rigidity and a lower hardness. It is thus possible to produce a large surface area of the connection terminal 2 and of the connection piece 3 from a soft plastic, which is more resistant to damage than the holding plate 14.

FIG. 4 illustrates schematically an arrangement as shown in FIG. 3, but in this embodiment the magnetic polarizations of the permanent magnets 7 and of the electromagnets 8 are selected such that, in the state in which no current is applied to the electromagnets 8, the connection terminal 2 and the connection piece 3 repel one another. In this embodiment, it is necessary for the control device 10 to drive the electromagnets 8 in the corresponding manner for the production of an electrical contact between the first and a second contact piece 5, 6 such that the magnetic polarization of the cores of the electromagnets 8 existing in the state in which no current is applied to the electromagnets 8 is superimposed by the magnetic field of the electromagnets 8, to which current is applied, and a magnetic attracting force results between the connection terminal 2 and the connection piece 3. If the control device 10 identifies that there is an emergency situation, it interrupts the application of current to the electromagnets 8. In the state in which no current is applied, the connection terminal 2 and the connection piece 3 repel one another such that the electrical contact between the first and the second contact piece 5, 6 is interrupted.

In this embodiment, the electromagnets 8 have permanent magnets as the magnet cores, which permanent magnets have the same magnetic polarization as the permanent magnets 7 of the connection terminal 2 on the side facing the permanent magnets 7 of the connection terminal 2 and, as a result, repel one another in the state in which no current is applied to the electromagnets 8. FIG. 4 illustrates the magnetic polarizations of the permanent magnets 7 and the electromagnets 8 in the state in which no current is applied to the electromagnets 8 by means of the capital letters S for south pole and N for north pole.

In one further preferred embodiment, a guide cage 15 is provided in which the connection piece 3 is held over the connection terminal 2. The guide cage 15 in this case surrounds the connection piece 3 and the connection terminal 2 in the form of a cylindrical sleeve, holding elements 16 being provided at a fixed distance from the upper side of the connection piece 3 and preventing the connection piece 3 from being lifted any further off the connection terminal 2 upwards and thus moving away from it. The guide cage 15 is held on the connection terminal 2 or on the battery 1. The guide cage 15 preferably has a cylindrical shape which is formed so as to correspond to the circular-disk shape of the connection piece 3, with the result that the connection piece 3 is guided axially by the guide cage 15. It is thus possible for the current supply to be switched off by the control device 10 for example when a motor vehicle is switched off, without the connection piece 3 being thrown away from the connection terminal 2. In the state in which no current is applied, the connection piece 3 floats at a fixed distance above the connection terminal 2. If the motor vehicle again has current applied to it and the control device 10 switches the current supply to the electromagnets 8 on again, the magnetic attracting force between the connection terminal 2 and the connection piece 3 takes effect. Owing to the guidance of the guide cage 15, when a current is applied to the electromagnets 8, the connection piece 3 is lowered onto the connection terminal 2 again, and an electrically conductive connection is produced between the first contact piece 5 and the second contact piece 6.

FIG. 5 shows a cross section through the arrangement in FIG. 4. FIG. 5 illustrates the state in which the electromagnets 8 do not have a current applied to them by the control device 10, and the connection piece 3 floats at a fixed distance above the connection piece 3 owing to the guidance of the guide cage 15 and owing to the magnetic repelling force acting between the connection terminal 2 and the connection piece 3. If a current is applied to the electromagnets 8 by the control device 10, the connection piece 3 is pulled downwards onto the connection terminal 2, the connection piece 3 being guided by the guide cage 15.

FIG. 6 shows a further embodiment of the contact arrangement which essentially corresponds to the embodiment in FIG. 3, but in this embodiment the electromagnets 8 are arranged in the connection terminal 2 and the permanent magnets 7 are arranged in the connection piece 3. The electromagnets 8 are connected to the control device 10 via a second electrical line 9. The magnetic polarizations of the electromagnets 8 and of the permanent magnets 7 are selected in such a manner that, in the state in which no current is applied to the electromagnets 8, the permanent magnets 7 and the electromagnets 8 attract one another. Of the four permanent magnets 7 arranged in the connection piece 3, two each have a magnetic south pole S at the end associated with the electromagnet 8 and the other two have a magnetic north pole N. In a symmetrical manner, the two magnet cores 18 of the electromagnets 8 of the connection terminal 2 have a magnetic south pole S on the side associated with the permanent magnets 7, and the cores of the two other electromagnets 8 have a magnetic north pole N. The connection terminal 2 and the connection piece 3 therefore attract one another in the state in which no current is applied to the electromagnets. If the electrical contact between a first and a second contact piece 5, 6 is intended to be interrupted, the control device 10 drives the electromagnets 8 such that the magnetic fields induced by the electromagnets 8 cause the permanent magnets 7 to repel one another.

### LIST OF REFERENCE SYMBOLS

1 Battery
2 Connection terminal
3 Connection piece
4 Electrical line
5 First contact piece
6 Second contact piece
7 Permanent magnet
8 Electromagnet
9 Second electrical line
10 Control device
11 Sensor
12 First connection
13 Second connection
14 Holding plate
15 Guide cage
16 Holding element
17 Magnet coil
18 Magnet core

1. A contact arrangement having a battery and an electrical line, the battery having a connection terminal for connecting the electrical line, the electrical line having a connection piece for connection to the connection terminal, the connection piece or the connection terminal having a permanent magnet, characterized in that the connection terminal or the connection piece has an electromagnet having a core and a magnet coil, in that the permanent magnet of the connection terminal or the connection piece is associated with the electromagnet of the connection piece or of the connection terminal, the permanent magnet exerting a magnetic force for the purpose of retaining or repelling the core, and in that the electromagnet counteracts the force effect of the permanent magnet owing to the supply of current, such that it is possible for the connection terminal to attract or repel the connection piece.

2. The arrangement as claimed in claim 1, characterized in that a plurality of permanent magnets are arranged in the connection terminal of the battery and/or in the connection piece of the line, in that a plurality of electromagnets are arranged in the connection terminal and/or in the connection piece, in that the permanent magnets are arranged symmetrically around an electrical contact piece of the connection terminal and/or of the connection piece, in that the electromagnets are arranged symmetrically around the electrical contact piece of the connection terminal and/or of the connection piece, the permanent magnets of the connection terminal and/or of the connection piece being associated with the electromagnets of the connection piece and/or of the connection terminal.

3. The arrangement as claimed in claim 2, characterized in that only electromagnets are arranged in the connection piece or in the connection terminal and only permanent magnets are arranged in the connection piece or in the connection terminal.

4. The arrangement as claimed in claim 1 characterized in that the connection piece has an electrically conductive contact piece, in that the connection terminal has an electrically conductive contact piece, in that the contact pieces have contact faces, and in that, in the contact state, the contact faces of the contact pieces bear against one another and make electrically conductive contact with one another.

5. The arrangement as claimed in claim 1 characterized in that the permanent magnets associated with one another in the connection piece and the connection terminal and the cores of the electromagnets have magnetic polarizations which bring about mutually repelling magnetic forces.

6. The arrangement as claimed in claim 1 characterized in that the permanent magnets and cores of the electromagnets associated with one another in the connection piece and the connection terminal have magnetic polarizations which bring about mutually attracting magnetic forces.

7. The arrangement as claimed in claim 1 characterized in that the connection terminal or the connection piece has four permanent magnets, which are arranged on a circle around the respective contact piece of the connection terminal or of the connection piece.

8. The arrangement as claimed in claim 1 characterized in that the permanent magnets and/or the magnet cores of the electromagnets are set back from the contact face of the connection piece or of the connection terminal via a spacer layer.

9. The arrangement as claimed in claim 1 characterized in that, in the contact state, only the contact pieces of the connection piece and of the connection terminal come into contact with one another.

10. The arrangement as claimed in claim 1 characterized in that a connection piece or a connection terminal has a plurality of electromagnets, and in that the magnet coils of the electromagnets are connected in series, and contact can be made with them via two connections on the connection piece or on the connection terminal.

11-12. (canceled)
